(19) United States
(12) Patent Application Publication
(10) Pub. No.: US 2026/0196829 A1
(43) Pub. Date: Jul. 9, 2026

(54) METHOD AND APPARATUS FOR CONTROLLING PARALLELED POWER SUPPLIES

(71) Applicant: L3Harris Technologies, Inc., Melbourne, FL (US)

(72) Inventor: Justin Malcolm GRAVES, Middletown, OH (US)

(21) Appl. No.: 19/008,760

(22) Filed: Jan. 3, 2025

(51) Int. Cl. H02J 1/10; H02M 1/00; H02M 3/158

(52) U.S. Cl. CPC H02J 1/102; H02M 1/0009; H02M 1/007; H02M 3/158

(57) ABSTRACT

A method of controlling multiple switching power supplies connected in parallel to have respective power inputs connected to each other to receive an input power and respective power outputs connected to each other at a combined power output to supply a total output power to a load, each switching power supply configured to, when enabled and disabled, respectively supply and not supply an individual power to the combined power output, comprises: sensing a level of current indicative of the total output power; when the level is a low level, enabling an initial switching power supply of the multiple switching power supplies and disabling remaining switching power supplies of the multiple switching power supplies; and as the level increases from the low level to a high level, successively enabling the remaining switching power supplies until the remaining switching power supplies are all enabled.

### TECHNICAL FIELD

The present disclosure relates to controlling power supplies.

### BACKGROUND

A power supply system may include multiple power supplies connected in parallel such that their individual power outputs are all connected to an output node to drive a load. During conventional operation, the power supplies are all always enabled or turned on to supply individual output powers to the output node in parallel, to supply a combined or total output power to the load. As output loading increases and decreases, the power supplies all react together to supply more or less total output power. For example, each power supply may increase its individual output power so that the power supplies collectively increase the total output power, or vice versa. A disadvantage of this collective response by all of the power supplies together is that an overall power supply efficiency of the power supply system suffers.

### BRIEF DESCRIPTION OF THE DRAWINGS

FIG. 1 is a block diagram of an example power supply system that includes paralleled power supplies controlled by a hysteretic efficiency controller (HEC) that improves power supply efficiency.

FIG. 2 is a block diagram that shows further details of the power supply system including the HEC.

FIG. 3 is a circuit diagram of an example current sensor and an example comparator with hysteresis used in the HEC, and an example PWM controller implemented in a power supply of the power supply system.

FIG. 4 is a block diagram of an example soft-start module of the HEC.

FIG. 5 shows waveforms in the power supply system as an illustration of power hysteresis.

FIG. 6 shows curves that exhibit a power supply efficiency boost achieved using the HEC to control the paralleled power supplies.

FIG. 7 is a flowchart of an example method of performing hysteretic control of multiple switching power supplies that are connected in parallel with each other.

FIG. 8 is a flowchart on another example method of performing hysteretic control of multiple power supplies connected in parallel.

FIG. 9 is a block diagram of an example controller configured to perform operations described herein.

### DESCRIPTION OF EXAMPLE EMBODIMENTS

### Overview

In an embodiment, a method of controlling multiple switching power supplies is provided. The multiple switching power supplies are connected in parallel to have respective power inputs connected to each other to receive an input power and respective power outputs connected to each other at a combined power output to supply a total output power to a load. Each switching power supply is configured to, when enabled and disabled, respectively supply and not supply an individual power to the combined power output. The method comprises: sensing a level of current indicative of the total output power; when the level is a low level, enabling an initial switching power supply of the multiple switching power supplies and disabling remaining switching power supplies of the multiple switching power supplies; and as the level increases from the low level to a high level, successively enabling the remaining switching power supplies until the remaining switching power supplies are all enabled.

### Example Embodiments

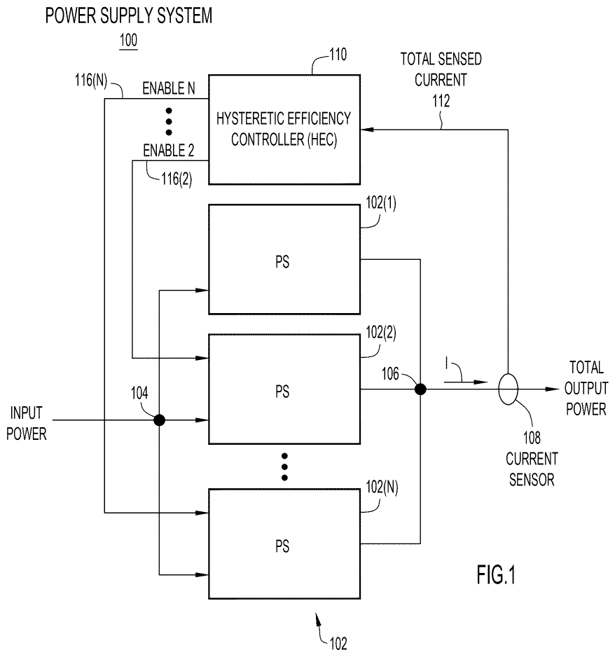

FIG. 1 is a block diagram of an example power supply system 100 that operates under hysteretic control to provide an improved power supply efficiency according to embodiments presented herein. Power supply system 100 includes power supplies (PSs) 102(1)-102(N) (collectively referred to as “power supplies 102”) connected in parallel. That is, power supplies 102(1)-102(N) have respective power inputs connected together at an input node 104 that receives input power, and respective power outputs connected together at an output node 106. Power supplies 102(1)-102(N) configured in this manner may be referred to as “paralleled” power supplies. In an example, power supplies 102 may be implemented as switching power supplies. In another example, power supplies may not be implemented as switching power supplies.

Power supplies 102(1)-102(N) may each be selectively enabled and disabled. When enabled, power supplies 102(1)-102(N) supply respective or individual output powers to output node 106, which combines the individual output powers into a total output power at the node. Power supplies 102(1)-102(N) collectively deliver the total power and a corresponding current I (and voltage) indicative of the total power to a load R connected to output node 106. When disabled (i.e., not enabled), power supplies 102(1)-102(N) do not supply respective output powers to output node 106. As used herein, the terms “enabled,” “energized,” and “turned on” are synonymous and may be used interchangeably. Similarly, the terms “disabled,” “deenergized,” and “turned off” are synonymous and may be used interchangeable.

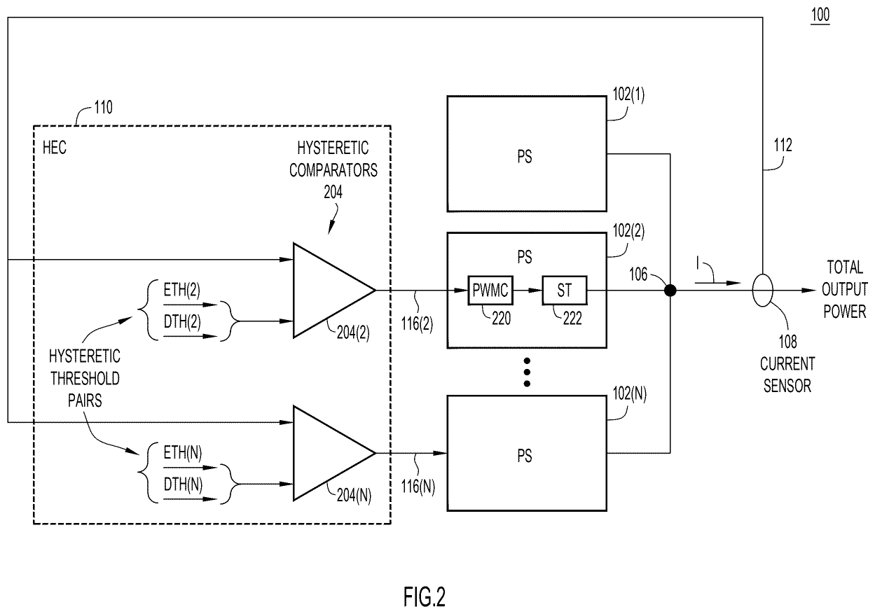

Power supply system 100 includes a current sensor (CS) 108 and a hysteretic efficiency controller (HEC) 110 both coupled to power supplies 102. In the example of FIG. 1, current sensor 108 and HEC 110 are shown as separate components; however, the current sensor may be integrated into the HEC. Current sensor 108 senses current I delivered to load R through output node 106 to produce a total sensed current 112 representative of a level of the current I (i.e., a current level), and provides the total sensed current to HEC 110. HEC 110 generates enable signals 116(2)-116(N) (also labeled “Enable 2”-“Enable N” in FIG. 1) in parallel based in part on total sensed current 112 and current thresholds (described below in connection with FIG. 2), and provides the enable signals to respective enable inputs of respective ones of power supplies 102(2)-102(N), in parallel. Enable signals 116(2)-116(N) represent control signals that enable or disable respective ones of power supplies 102(2)-102(N) depending on respective states of the enable signals. In the example, power supply 102(1) operates/is configured as an always-enabled power supply. In one arrangement, HEC 110 may supply an enable signal (not shown) to power supply 102(1) and assert the enable signal to a state that always enables the power supply. In another arrangement, an external circuit (not shown) may supply the enable signal to power supply 102(1) such that the enable signal is in the state that always enables power supply 102(1).

Power supplies 102 ramp up and ramp down the total output power supplied to load R under control of HEC 110 in the following manner. Initially, the total output power is low and the current I is at a low level. At the low level, power supply 102(1) (e.g., an “initial” power supply) is enabled to supply current I to load R, and HEC 110 generates enable signals 116(2)-116(N) to disable power supplies 102(2)-102(N) responsive to the total sensed current 112. Thus, only power supply 102(1) supplies individual output power to output node 106, while “remaining” power supplies 102(2)-102(N) are disabled responsive to enable signals 116(2)-116(N). As the level of current I increases from the low level to a high level (e.g., a maximum level) responsive to changes in load R, HEC 110 generates enable signals 116(2)-116(N) based on the increasing level of current I to successively (i.e., incrementally) and cumulatively enable remaining power supplies 102(2)-102(N) until they are all enabled at the high level. For example, HEC 110 enables power supplies (i) 102(2), (ii) (102(2) and 102(3)), (iii) (102(2), 102(3), and 102(4)), (iv) (102(2), 102(3), 102(4), and 102(5)), and so on, in a time-ordered sequence in response to the increase in the level of current I. As used herein, the term “successive” means one at a time (i.e., incrementally) in a time-ordered sequence.

Next, assume that the level of the current I decreases from the high level to the low level responsive to changes in load R. Responsive to the decrease in the level of current I, HEC 110 generates enable signals 116(2)-116(N) to successively disable (initially enabled) remaining power supplies 102(2)-102(N) in a reverse order until they are all disabled. For example, HEC disables power supplies 102(N), (102(N) and 102(N−1)), (102(N), 102(N−2), 102(N−3)), and so on, in a time-ordered sequence that is reverse to the order in which the power supplies were enabled.

FIG. 2 is a block diagram that shows further details of power supply system 100. HEC 110 includes comparators 204(2)-204(N) (collectively referred to as “comparators 204”) to generate respective ones of enable signals 116(2)-116(N) in parallel, to control respective ones of power supplies 102(2)-102(N) in parallel. Comparators 204(2)-204(N) may be hysteretic comparators, for example. HEC 110 is configured with enable thresholds ETH(2)-ETH(N) that are assigned to/associated with respective ones of power supplies 102(2)-102(N). Accordingly, power supplies 204(2)-204(N) are said to have respective enable thresholds ETH(2)-ETH(N). Enable thresholds ETH(2)-ETH(N) represent successively increasing current thresholds that are used only to enable (not disable) power supplies 102(2)-102(N) responsive to an increasing level of current I. Enable thresholds ETH(2)-ETH(N) successively increase such that ETH(2)<ETH(3)<ETH(4), and so on, where enable thresholds ETH(2) and ETH(N) respectively represent the lowest and highest enable thresholds.

HEC 110 applies enable thresholds ETH(2)-ETH(N) to respective ones of comparators 204(2)-204(N), and also applies total sensed current 112 to each of the comparators in parallel with the enable thresholds. For example, comparator 204(2) receives as inputs total sensed current 112 and enable threshold ETH(2), comparator 204(3) receives as inputs total sensed current 112 and enable threshold ETH(3), and so on. More generally, a given comparator 204(i) (where i=2 to N) receives as inputs enable threshold ETH(i) and total sensed current 112.

Given comparator 204(i) (e.g., comparator 204(2), comparator 204(3), and so on) operates similarly to, and in parallel with, the other comparators. Therefore, the following description of comparator 204(i) shall suffice for the other comparators. In operation, comparator 204(i) compares the level of current I (as represented by total sensed current 112) against enable threshold ETH(i), to produce enable signal 116(i) as an individual compare result, and provides the enable signal to power supply 102(i). Assuming that power supply 102(i) is not currently enabled, when the level of current I exceeds enable threshold ETH(i), comparator 204(i) asserts enable signal 116(i) to a first state that enables the power supply 102(i). That is, the level of current I that exceeds enable threshold ETH(i) enables power supply 204(i).

Comparator 204(i) also derives a disable threshold DTH(i) that is less than enable threshold ETH(i) based on enable threshold ETH(i) and feedback of enable signal 116(i) once asserted to the first state. Once power supply 204(i) is enabled, comparator 204(i) uses disable threshold DTH(i) only to disable power supply 102(i) responsive to a decreasing level of current I. Specifically, comparator 204(i) compares the level of current I against disable threshold DTH(i). When the level of current I falls below disable threshold DTH(i) (which is also less than enable threshold ETH(i)), comparator 204(i) asserts enable signal 116(i) to a second state that disables the power supply 102(i). In an example in which power supplies 102(2)-102(N) are all enabled responsive to a high level of current I, comparators 204(2)-204(N) derive respective disable thresholds DTH(2)-DTH(N) used by the comparators to disable power supplies 102 successively as the level of current I falls below disable thresholds DTH(2)-DTH(N) successively. Accordingly, power supplies 102(2)-102(N) are said to have respective disable thresholds DTH(2)-DTH(N).

In summary, comparator 204(i) only enables power supply 102(i) when the level of current I exceeds enable threshold ETH(i) and then only disables the (enabled) power supply 102(i) when the level of current I falls below (i.e., is less than) disable threshold DTH(i). Enable threshold ETH(i) and disable threshold DTH(i) represent a pair of differential/hysteretic thresholds employed by comparator 204(i) to establish hysteresis when enabling and disabling power supply 102(i). The pair of hysteretic thresholds ETH(i), DTH(i) are greater than the previous pair ETH(i−1), DTH(i−1), and less than the next pair ETH(i+1), DTH(i+1). The hysteresis prevents rapid switching between enabling and disabling power supply 102(i) responsive to small (e.g., noise) fluctuations in the level of current I that might otherwise occur in the absence of the hysteresis.

Comparators 204(2)-204(N) enable different combinations of power supplies 102(2)-102(N) depending on different levels of current I. A given level of current I enables all power supplies that have enable thresholds below that level. For example:
a. When the level is less than enable threshold ETH(1) (the lowest enable threshold), only power supply 102(1) is enabled.
b. When the level is between enable thresholds ETH(3) and ETH(4), only power supplies 102(1), 102(2), and 102(3) are enabled.
c. When the level exceeds ETH(N), all of the power supplies are enabled.

Power supplies 102(1)-102(N) may be implemented as switching power supplies. In FIG. 2, power supply 102(2) is presented as a switching power supply. The other power supplies may be configured similarly to power supply 102(2). Therefore, the description of power supply 102(2) shall suffice for the other power supplies. Power supply 102(2) includes a PWM controller (PWMC) 220 and one or more switching transistors (STs) 222. The switching transistors may be FETs, for example. When enabled, PWM controller 220 supplies PWM (e.g., a pulse train) to switching transistors 222. For example, PWM controller 220 supplies the PWM to gates of the FETs. Responsive to the PWM, switching transistors 222 cycle on and off to supply individual output power to output node 106. Thus, when PWM controller 220 is enabled, power supply 102(2) is enabled. When PWM controller 220 is disabled, PWM controller 220 does not supply the PWM to switching transistors 222, which do not supply the individual output power to output node 106. Thus, when PWM controller 220 is disabled, power supply 102(2) is disabled.

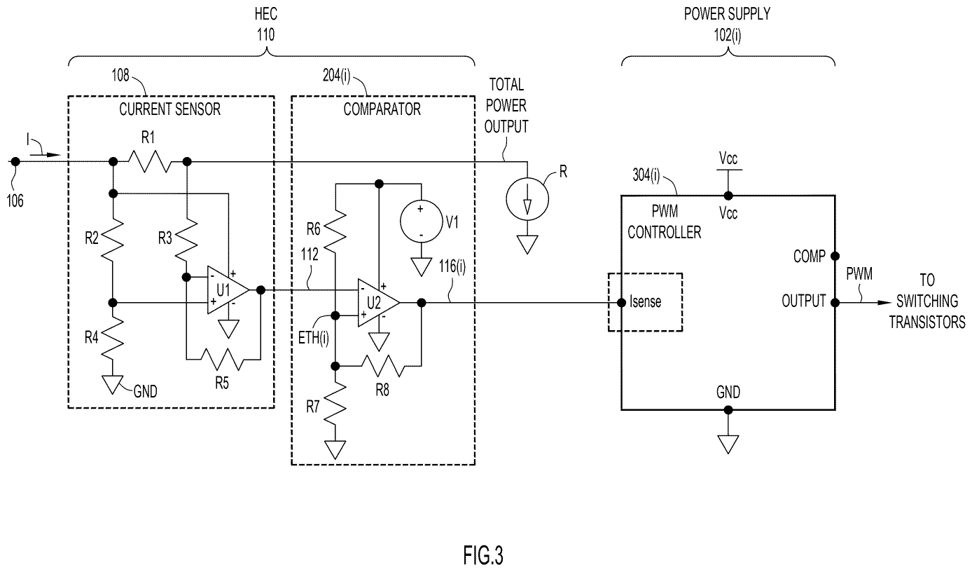

PWM controller 220 is enabled or disabled (and thus, power supply 102(2) is correspondingly enabled or disabled) depending on a state of enable signal 116(2) asserted by comparator 204(2). For example, the first and second states of enable signal 116(2) described above enable and disable PWM controller 220 (and thus power supply 102(2)), as is further described below in connection with FIG. 3.

FIG. 3 is a circuit diagram of current sensor 108, comparator 204(i) with hysteresis (where i=2 to N), and a PWM controller 304(i) (e.g., PWM controller 220) implemented in a power supply 102(i) (e.g., power supply 102(2)), according to an embodiment. Current sensor 108 includes a current sense resistor R1 connected in-line from output node 106 to load R. Current sensor 108 also includes (i) a resistive potential divider comprising series-connected resistors R2 and R4, and (ii) a resistor R3, respectively configured to apply a sensed voltage across resistor R1 that results from current I to differential inputs of an operational amplifier (Op Amp) U1. Based on the sensed voltage, amplifier U1 produces (at its output) total sensed current 112 indicative of the level of current I, and provides the same to comparator 204(i).

Comparator 204(i) includes an Op Amp U2 having a positive input, a negative input to receive total sensed current 112, and an output. Comparator 204(i) also includes a resistive divider comprising series-connected resistors R6 and R7 to derive an enable threshold ETH(i) from a voltage V1 (which may be a power rail voltage VCC), and to apply the enable threshold to the positive input of Op Amp U2. Selectable values of R6 and R7 set the enable threshold ETH(i). Op Amp U2 compares total sensed current 112 (i.e., the level of current I) against enable threshold ETH(i) to produce enable signal 116(i) as described above. Comparator 204(i) includes a feedback resistor R8, connected from the output of Op Amp U2 to its positive input, to provide hysteretic feedback that derives disable threshold DTH(i) based on enable threshold ETH(i) and enable signal 116(i).

PWM controller 304(i) may be any known or hereafter developed PWM controller. In the example of FIG. 3, PWM controller 304(i) is configured, and operates, according to a known current mode PWM standard. An example of such a PWM controller includes a Linear Technology (LT) LT1243 pulse width modulator. PWM controller 304(i) includes the following pinout arrangement (i.e., pinouts) consistent with the current mode PWM standard, and that is relevant to the embodiments. The pinouts include an output pin, a current sense (ISENSE) input pin (also referred to as a “first input”), and a compensation (COMP) input pin (also referred to as a “second input”).

The output pin supplies or does not supply PWM when the PWM controller is enabled or disabled, respectively. The ISENSE input pin receives a voltage that enables or disables the PWM controller. When the voltage is a high level that exceeds a predetermined voltage threshold (e.g., 1 V), the PWM controller is disabled. Conversely, when the voltage is a low level that does not exceed the predetermined voltage threshold (and is therefore less than the high level), the PWM controller is enabled to supply PWM from the output pin.

The COMP input pin receives a voltage to enable or disable the PWM controller, and to control a duty cycle of the PWM. When the voltage is a low level (e.g., 0 V), the PWM controller is disabled (i.e., a duty cycle of the PWM is zero). As the voltage gradually increases from the low level to a high level (e.g., a maximum level) that is greater than the low level, the duty cycle gradually increases from zero to a maximum or full duty cycle. Thus, the PWM supplied by the output pin is off in response to the low level voltage, and the PWM is fully on in response to the high level voltage. Gradually increasing the PWM from zero duty cycle to the maximum duty cycle, results in gradually increasing an output power of power supply 102(i). Such operation may be referred to as “soft starting” power supply 102(i).

In the example of FIG. 3, comparator 204(i) applies enable signal 116(i) to the ISENSE input pin of PWM controller 304(i). To enable power supply 102(i), comparator 204(i) asserts enable signal 116(i) to a low level (referred to above as the “first state”). Conversely, to disable power supply 102(i), comparator 204(i) asserts enable signal 116(i) to a high level (referred to above as the “second state”).

In another example, comparator 204(i) applies enable signal 116(i) to the COMP input of PWM controller 304(i). To enable power supply 102(i), comparator 204(i) asserts enable signal 116(i) to a high level (referred to above as the “first state”). Conversely, to disable power supply 102(i), comparator 204(i) asserts enable signal 116(i) to a low level (referred to above as the “second state”). In another arrangement described below, HEC 110 employs comparator 204(i) (and enable signal 204(i)) to assist with performing a soft start of power supply 102(i).

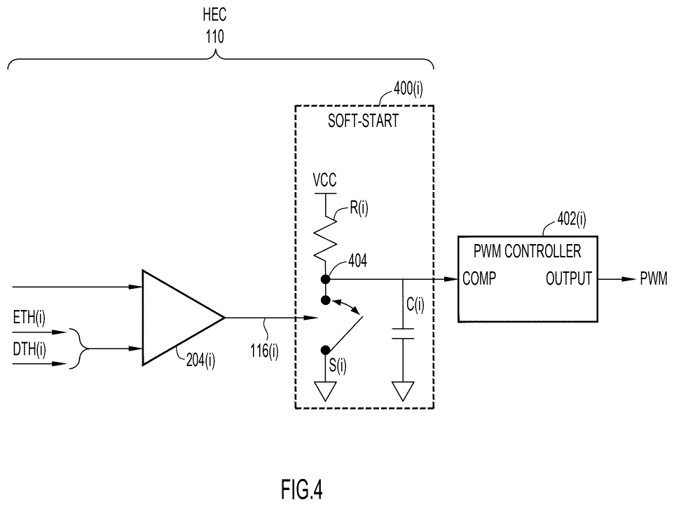

FIG. 4 is a block diagram of an example soft-start module 400(i) of HEC 110 for performing a soft-start of power supply 102(i), where i=2 to N. HEC 110 may include N−1 such soft-start modules, one for each power supply 102(i). Soft-start module 400(i) includes a resistor R(i) and a soft-start capacitor C(i) connected in series with each other from VCC to ground, and to each other at a node 404. Node 404 is connected to the COMP input pin of a PWM controller 402(i) of power supply 102(i). Soft-start module 400(i) further includes a switch S(i) connected from node 404 to ground, and controlled (i.e., opened or closed) responsive to enable signal 116(i) supplied by comparator 204(i). Switch S(i) may be a FET switch that is controlled (i.e., turned on to close the switch or turned off to open the switch) responsive to a voltage (e.g., a voltage of enable signal 116(i)) applied to a gate of the FET.

To disable PWM controller 402(i), comparator 204(i) asserts enable signal 116(i) to a state (e.g., the second state) that closes switch S(i). When closed, switch S(i) pulls node 404 to ground (i.e., to a low level). Node 404 applies the low level to the COMP input pin, which disables PWM controller 402(i). To enable PWM controller 402(i), comparator asserts enable signal 116(i) to a state (e.g., a first state) that opens switch S(i). With switch S(i) opened, VCC gradually charges C(i) through R(i). As C(i) gradually charges, the voltage at node 404 (and thus at the COMP input pin) gradually increases from the low level to a high level (i.e., a maximum level) when C(i) is fully charged. As the voltage at the COMP input pin gradually increases from the low level to the high level, the duty cycle supplied by PWM controller 402(i) gradually increases from zero to a maximum duty cycle to soft start power supply 102(i).

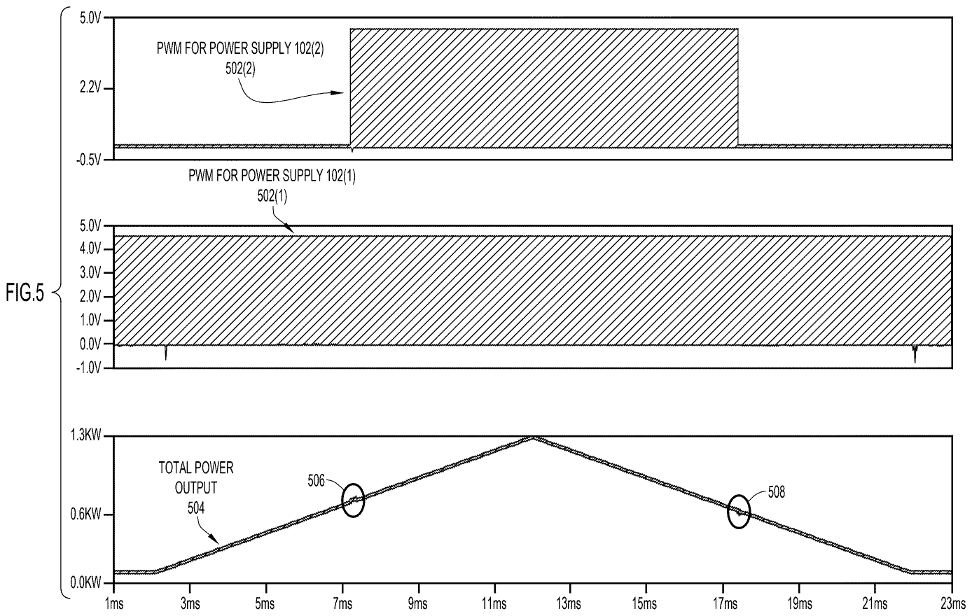

FIG. 5 is an illustration of power hysteresis implemented in power supply system 100 over a segment of time. FIG. 5 shows waveforms for PWM 502(1) for power supply 102(1), PWM 502(2) for power supply 102(2), and a total output power 504, which are all time-aligned across the segment of time. The voltage levels, power levels, and times presented in FIG. 5 are examples. PWM 502(1) is always enabled (i.e., on). Thus, power supply 102(1) is always enabled to supply individual output power.

Total output power 504 ramps up or increases from 92 W to 1300 W, and then ramps down or decreases from 1300 W to 92 W. Throughout the ramp up and the ramp down, PWM 502(1) is always enabled (i.e., on), and thus power supply 102(1) is always enabled to supply individual output power. On the ramp up, initially, PWM 502(2) is disabled (i.e., off), and thus power supply 102(2) is disabled. At 506, PWM 502(2) becomes enabled (i.e., turns on) when the total output power 504 rises above 711 W, which represents enable threshold ETH(2). On the ramp down, PWM 502(2) remains enabled (i.e., turned on) until, at 508, total output power 504 fall below 651 W, which represents the disable threshold DTH(2). The difference between 711 W (when power supply 102(2) is enabled) and 651 W (when power supply 102(2) is disabled) represents 60 W of power hysteresis. The power hysteresis protects the paralleled power supplies from potentially destructive “chattering” when transitioning between normal and high-efficiency modes.

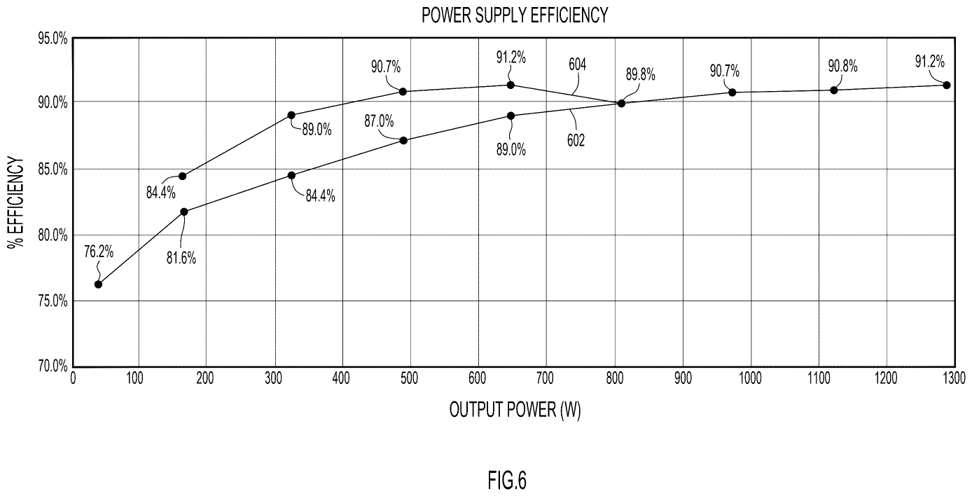

FIG. 6 shows a power supply efficiency boost that can be achieved using HEC 110 to control paralleled power supplies. FIG. 6 shows an example conventional power supply efficiency curve 602 for a conventional 1300 W power supply that includes two paralleled 650 W power supplies that are always enabled. That is, the conventional 1300 W power supply does not include HEC 110 to selectively enable and disable the paralleled power supplies as described above.

FIG. 6 also shows an example power supply efficiency curve 604 for a 1300 W power supply that includes two paralleled 650 W power supplies (e.g., power supplies 102(1) and 102(2)) that operate under control of HEC 110. At 1300 W, HEC 110 enables both of the paralleled powers supplies. As the total output power falls, at 650 W, HEC 110 disables one of the paralleled power supplies, which remains disabled as the total output power falls further. Power supply efficiency curve 604 shows an efficiency boost below 650 W that results from selectively disabling the one power supply relative to conventional power supply efficiency curve 602.

The example of FIG. 6 represents two paralleled power supplies operating under control of HEC 110, but more paralleled power supplies may be used in other arrangements. For example, using four paralleled 325 W power supplies that operate under control of HEC 110 (e.g., 325 W·4=1300 W maximum total output power) may provide greater than 90% efficiency from 1300 W to approximately 200 W.

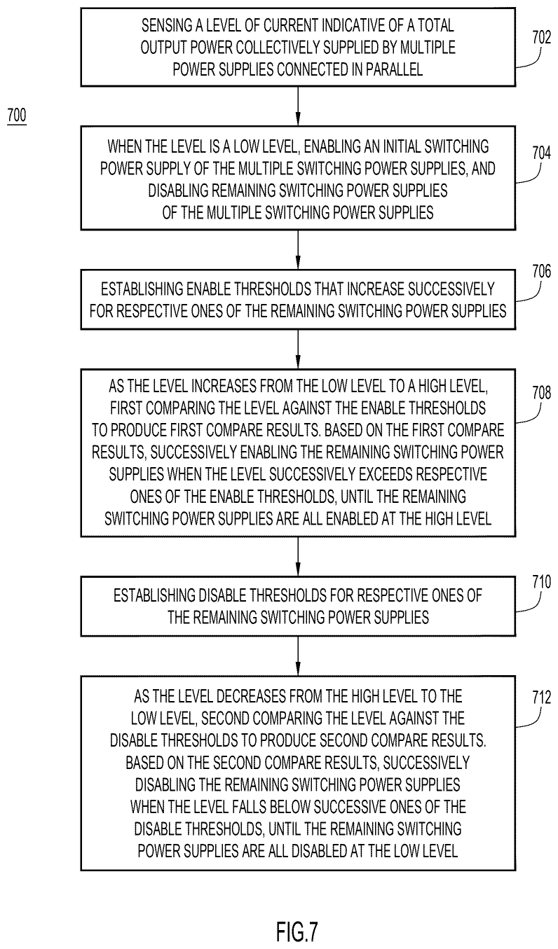

FIG. 7 is a flowchart on an example method 700 of performing hysteretic control of multiple switching power supplies that are connected in parallel with each other. The multiple power supplies have respective power inputs connected to each other to receive an input power and respective power outputs connected to each other at a combined power output to supply a total output power to a load. Each switching power supply is configured to, when enabled and disabled, respectively supply and not supply an individual power to the combined power output. Method 700 may be performed primarily by HEC 110 of power supply system 100, for example.

702 includes sensing a level of current indicative of the total output power.

704 includes, when the level is a low level, enabling an initial switching power supply of the multiple switching power supplies and disabling remaining switching power supplies of the multiple switching power supplies.

706 includes establishing enable thresholds that increase successively for respective ones of the remaining switching power supplies. Establishing may include assigning/associating the enable thresholds to/with respective ones of the remaining switching power supplies.

708 includes, as the level increases from the low level to a high level, first comparing the level against the enable thresholds to produce first compare results (e.g., enable signals). 708 further includes, based on the first compare results, successively and cumulatively enabling the remaining switching power supplies when the level successively exceeds respective ones of the enable thresholds, until the remaining switching power supplies are all enabled at the high level.

In an example, the multiple switching power supplies respectively include PWM controllers that, when enabled and disabled, supply and do not supply PWM to one or more switching transistors of each of the multiple switching power supplies. In the example, enabling a particular switching power supply includes enabling a particular PWM controller of the particular switching power supply. Enabling may include asserting a voltage on an enable pin (e.g., an ISENSE input pin or a COMP input pin) of the particular PWM controller to a high level or a low level, depending on a type of the PWM controller. Enabling may include gradually increasing the voltage, and thereby gradually increasing a duty cycle of PWM produced by the PWM controller to achieve a soft start.

710 includes establishing disable thresholds for respective ones of the remaining switching power supplies, such that each disable threshold is less than a respective one of the enable thresholds (i.e., the enable thresholds are greater than respective ones of the disable thresholds). Establishing may include assigning/associating the disable thresholds to/with respective ones of the remaining switching power supplies. Establishing may include deriving the disable thresholds based on the enable thresholds and feedback of the first compare results (e.g., the enable signals). Pairs of the enable thresholds and the disable thresholds represent pairs of hysteretic thresholds for enabling and disabling respective ones of the remaining power supplies, to implement hysteresis.

712 includes, as the level decreases from the high level to the low level, second comparing the level against the disable thresholds to produce second compare results (e.g., disable signals). 712 further includes, based on the second compare results, successively disabling the remaining switching power supplies (which are enabled) when the level falls below successive ones of the disable thresholds (successive in a decreasing sense), until the remaining switching power supplies are all disabled at the low level. Disabling may include asserting the voltage on the enable pin of the particular PWM controller to a high level or to a low level depending on the type of PWM controller. The enable thresholds and the disable thresholds establish hysteresis when enabling and disabling the remaining switching power supplies.

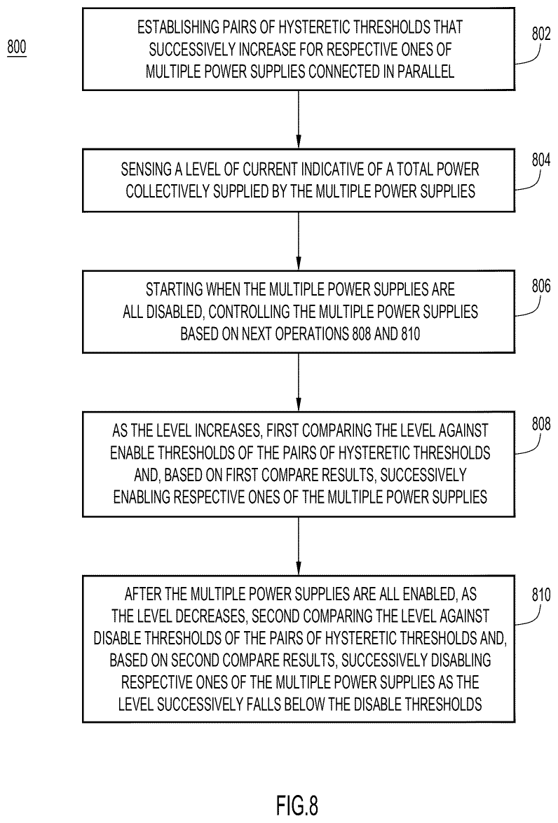

FIG. 8 is a flowchart on another example method 800 of performing hysteretic control of multiple power supplies connected in parallel to supply a total output power to a load. When enabled and disabled, each power supply respectively supplies (i.e., contributes) and does not supply (i.e., does not contribute) an individual power to the total power.

802 includes establishing pairs of hysteretic thresholds that successively increase for respective ones of the multiple power supplies.

804 includes sensing a level of current indicative of the total output power.

806 includes, starting when the multiple power supplies are all disabled, controlling the multiple power supplies based on next operations 808-810.

808 includes, as the level increases from a low level to a high level, first comparing the level against enable thresholds of the pairs of the hysteretic thresholds and, based on first compare results, successively and cumulatively enabling respective ones of the multiple power supplies as the level successively exceeds successive ones of the enable thresholds until the multiple power supplies are all enabled.

810 includes, after the multiple power supplies are all enabled, as the level decreases, second comparing the level against disable thresholds of the pairs of the hysteretic thresholds and, based on second compare results, successively disabling respective ones of the multiple power supplies as the level successively falls below successive ones of the disable thresholds.

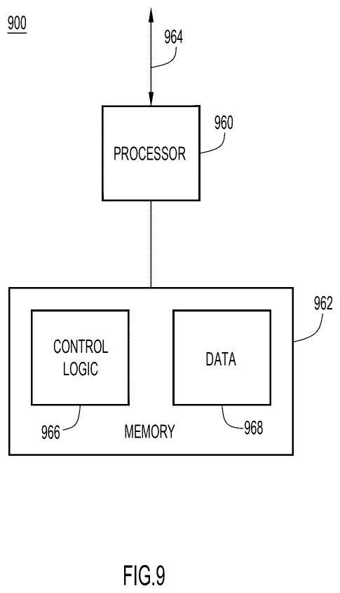

FIG. 9 is block diagram of an example controller 900 configured to perform operations described herein. Controller 900 may represent HEC 110 for example. Controller 900 includes processor(s) 960 and a memory 962 coupled to one another. The aforementioned components may be implemented in hardware (e.g., a hardware processor), software (e.g., a software processor), or a combination thereof. Processor(s) 960 communicate with other entities/processes over hardware and/or software interfaces 964, e.g., to receive total sensed current 112 and to supply enable signals 116(2)-116(N) to switching power supplies 102(2)-102(N), for example. Controller 900 may employ analog-to-digital converters (ADCs) and digital-to-analog converters (DACs) to convert various signals as part of the operations described herein.

Memory 962 stores control software 966 (referred as “control logic”), that when executed by the processor(s) 960, causes the processor(s), and more generally, controller 900, to perform the various operations described herein. The processor(s) 960 may be a microprocessor or microcontroller (or multiple instances of such components). The memory 962 may include read only memory (ROM), random access memory (RAM), magnetic disk storage media devices, optical storage media devices, flash memory devices, electrical, optical, or other physically tangible (i.e., non-transitory) memory storage devices. Controller 900 may also be discrete logic embedded within an integrated circuit (IC) device.

Thus, in general, the memory 962 may comprise one or more tangible (non-transitory) computer readable storage media (e.g., memory device(s)) including a first non-transitory computer readable storage medium, a second non-transitory computer readable storage medium, and so on, encoded with software or firmware that comprises computer executable instructions. For example, control software 966 includes logic to implement operations performed by the controller 900. Thus, control software 966 implements the various methods/operations described herein.

In addition, memory 962 stores data 968 used and produced by control software 966.

In some aspects, the techniques described herein relate to a method of controlling multiple switching power supplies connected in parallel to have respective power inputs connected to each other to receive an input power and respective power outputs connected to each other at a combined power output to supply a total output power to a load, each switching power supply configured to, when enabled and disabled, respectively supply and not supply an individual power to the combined power output, the method including: sensing a level of current indicative of the total output power; when the level is a low level, enabling an initial switching power supply of the multiple switching power supplies and disabling remaining switching power supplies of the multiple switching power supplies; and as the level increases from the low level to a high level, successively enabling the remaining switching power supplies until the remaining switching power supplies are all enabled.

In some aspects, the techniques described herein relate to a method, further including: as the level decreases from the high level to the low level, successively disabling the remaining switching power supplies until all the remaining switching power supplies are disabled.

In some aspects, the techniques described herein relate to a method, further including: establishing enable thresholds that increase successively for respective ones of the remaining switching power supplies; and as the level increases, comparing the level against the enable thresholds, wherein successively enabling includes successively enabling the remaining switching power supplies when the level exceeds successive ones of the enable thresholds, based on results of comparing.

In some aspects, the techniques described herein relate to a method, further including: establishing disable thresholds for respective ones of the remaining switching power supplies, such that each disable threshold is less than a respective one of the enable thresholds; as the level decreases from the high level, comparing the level against the disable thresholds; and as the level decreases, successively disabling the remaining switching power supplies that are enabled when the level falls below successive ones of the disable thresholds, based on results of comparing, wherein the enable thresholds and the disable thresholds establish hysteresis when enabling and disabling the remaining switching power supplies.

In some aspects, the techniques described herein relate to a method, wherein the multiple switching power supplies respectively include pulse width modulation (PWM) controllers that, when enabled and disabled, supply and do not supply PWM to one or more switching transistors of each of the multiple switching power supplies, and wherein: enabling a particular switching power supply includes enabling a particular PWM controller of the particular switching power supply.

In some aspects, the techniques described herein relate to a method, wherein the particular PWM controller includes an enable input to receive a voltage that enables or disables the particular PWM controller when the voltage exceeds or does not exceed a threshold voltage, and wherein: enabling the particular PWM controller includes applying the voltage that exceeds the threshold voltage to the enable input.

In some aspects, the techniques described herein relate to a method, wherein the particular PWM controller includes an enable input to receive a voltage that enables or disables the particular PWM controller when the voltage is less than or is not less than a threshold voltage, and wherein: enabling the particular PWM controller includes applying to the enable input the voltage that is less than the threshold voltage.

In some aspects, the techniques described herein relate to a method, wherein the particular PWM controller includes a duty cycle control input to receive a voltage to gradually increase a duty cycle of the PWM from zero to a maximum duty cycle as the voltage gradually increases from a low voltage to a high voltage, and wherein: enabling the particular PWM controller includes gradually increasing the voltage from the high voltage to the low voltage.

In some aspects, the techniques described herein relate to a power supply system including: multiple switching power supplies having respective power inputs connected to each other and respective power outputs connected to each other at a combined output to supply a total output power to a load, each switching power supply configured to, when enabled and disabled, respectively supply and not supply an individual power to the combined output; and a controller coupled to the multiple switching power supplies and configured to perform: sensing a level of current indicative of the total output power; when the level is a low level, enabling an initial switching power supply of the multiple switching power supplies and disabling remaining switching power supplies of the multiple switching power supplies; and as the level increases from the low level to a high level, successively enabling the remaining switching power supplies until the remaining switching power supplies are enabled.

In some aspects, the techniques described herein relate to a power supply system, wherein the controller is further configured to perform: as the level decreases from the high level to the low level, successively disabling the remaining switching power supplies until all the remaining switching power supplies are disabled.

In some aspects, the techniques described herein relate to a power supply system, wherein the controller is further configured to perform: establishing enable thresholds that increase successively for respective ones of the remaining switching power supplies; and as the level increases, comparing the level against the enable thresholds, wherein the controller is configured to perform successively enabling by successively enabling the remaining switching power supplies when the level exceeds successive ones of the enable thresholds, based on results of comparing.

In some aspects, the techniques described herein relate to a power supply system, wherein the controller is further configured to perform: establishing disable thresholds for respective ones of the remaining switching power supplies, such that each disable threshold is less than a respective one of the enable thresholds; as the level decreases from the high level, comparing the level against the disable thresholds; and as the level decreases, successively disabling the remaining switching power supplies that are enabled when the level falls below successive ones of the disable thresholds, based on results of comparing.

In some aspects, the techniques described herein relate to a power supply system, wherein: each switching power supply respectively includes a pulse width modulation (PWM) controller that, when enabled and disabled, supplies and does not supply PWM to one or more switching transistors; and the controller is configured to perform enabling a particular switching power supply by enabling a particular PWM controller of the particular switching power supply.

In some aspects, the techniques described herein relate to a power supply system, wherein: the particular PWM controller includes an enable input to receive a voltage that enables or disables the particular PWM controller when the voltage exceeds or does not exceed a threshold voltage; and the controller is configured to perform enabling the particular PWM controller includes applying the voltage that exceeds the threshold voltage to the enable input.

In some aspects, the techniques described herein relate to a power supply system, wherein: the particular PWM controller includes an enable input to receive a voltage that enables or disables the particular PWM controller when the voltage is less than or is not less than a threshold voltage; and the controller is configured to perform enabling the particular PWM controller includes applying to the enable input the voltage that is less than the threshold voltage.

In some aspects, the techniques described herein relate to a power supply system, wherein: the particular PWM controller includes a duty cycle control input to receive a voltage to gradually increase a duty cycle of the PWM from zero to a maximum duty cycle as the voltage gradually increases from a low voltage to a high voltage; and the controller is configured to perform enabling the particular PWM controller includes gradually increasing the voltage from the low voltage to the high voltage.

In some aspects, the techniques described herein relate to a method of controlling multiple power supplies connected in parallel to supply a total output power to a load, each power supply configured to, when enabled and disabled, respectively supply and not supply an individual power to the total output power, the method including: establishing pairs of hysteretic thresholds that successively increase for respective ones of the multiple power supplies; sensing a level of current indicative of the total output power; and starting when the multiple power supplies are all disabled, controlling the multiple power supplies based on the level by: as the level increases, successively enabling the multiple power supplies as the level successively exceeds enable thresholds of the pairs of the hysteretic thresholds until the multiple power supplies are all enabled; and after the multiple power supplies are all enabled, as the level decreases, successively disabling the multiple power supplies as the level successively falls below disable thresholds of the pairs of the hysteretic thresholds.

In some aspects, the techniques described herein relate to a method, wherein the multiple power supplies include switching power supply that include respective pulse width modulator (PWM) controllers, wherein: successively enabling includes successively enabling the PWM controllers.

In some aspects, the techniques described herein relate to a method, wherein: successively disabling includes successively disabling the PWM controllers.

In some aspects, the techniques described herein relate to a method, further including: as the level increases, first comparing the level against the enable thresholds, and successively enabling based on first results of first comparing; and as the level decreases, second comparing the level against the disable thresholds, and successively disabling based on second results of second comparing.

In some aspects, the techniques described herein relate to a method, wherein: each enable threshold is greater than a respective one of the disable thresholds to establish hysteresis in enabling and disabling the multiple power supplies.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method of controlling multiple switching power supplies connected in parallel to have respective power inputs connected to each other to receive an input power and respective power outputs connected to each other at a combined power output to supply a total output power to a load, each switching power supply configured to, when enabled and disabled, respectively supply and not supply an individual power to the combined power output, the method comprising:
sensing a level of current indicative of the total output power;
when the level is a low level, enabling an initial switching power supply of the multiple switching power supplies and disabling remaining switching power supplies of the multiple switching power supplies; and
as the level increases from the low level to a high level, successively enabling the remaining switching power supplies until the remaining switching power supplies are all enabled.

2. The method of claim 1, further comprising:
as the level decreases from the high level to the low level, successively disabling the remaining switching power supplies until all the remaining switching power supplies are disabled.

3. The method of claim 1, further comprising:
establishing enable thresholds that increase successively for respective ones of the remaining switching power supplies; and
as the level increases, comparing the level against the enable thresholds,
wherein successively enabling includes successively enabling the remaining switching power supplies when the level exceeds successive ones of the enable thresholds, based on results of comparing.

4. The method of claim 3, further comprising:
establishing disable thresholds for respective ones of the remaining switching power supplies, such that each disable threshold is less than a respective one of the enable thresholds;
as the level decreases from the high level, comparing the level against the disable thresholds; and
as the level decreases, successively disabling the remaining switching power supplies that are enabled when the level falls below successive ones of the disable thresholds, based on results of comparing, wherein the enable thresholds and the disable thresholds establish hysteresis when enabling and disabling the remaining switching power supplies.

5. The method of claim 1, wherein the multiple switching power supplies respectively include pulse width modulation (PWM) controllers that, when enabled and disabled, supply and do not supply PWM to one or more switching transistors of each of the multiple switching power supplies, and wherein:
enabling a particular switching power supply includes enabling a particular PWM controller of the particular switching power supply.

6. The method of claim 5, wherein the particular PWM controller includes an enable input to receive a voltage that enables or disables the particular PWM controller when the voltage exceeds or does not exceed a threshold voltage, and wherein:
enabling the particular PWM controller includes applying the voltage that exceeds the threshold voltage to the enable input.

7. The method of claim 5, wherein the particular PWM controller includes an enable input to receive a voltage that enables or disables the particular PWM controller when the voltage is less than or is not less than a threshold voltage, and wherein:
enabling the particular PWM controller includes applying to the enable input the voltage that is less than the threshold voltage.

8. The method of claim 5, wherein the particular PWM controller includes a duty cycle control input to receive a voltage to gradually increase a duty cycle of the PWM from zero to a maximum duty cycle as the voltage gradually increases from a low voltage to a high voltage, and wherein:
enabling the particular PWM controller includes gradually increasing the voltage from the high voltage to the low voltage.

9. A power supply system comprising:
multiple switching power supplies having respective power inputs connected to each other and respective power outputs connected to each other at a combined output to supply a total output power to a load, each switching power supply configured to, when enabled and disabled, respectively supply and not supply an individual power to the combined output; and
a controller coupled to the multiple switching power supplies and configured to perform:
sensing a level of current indicative of the total output power;
when the level is a low level, enabling an initial switching power supply of the multiple switching power supplies and disabling remaining switching power supplies of the multiple switching power supplies; and
as the level increases from the low level to a high level, successively enabling the remaining switching power supplies until the remaining switching power supplies are enabled.

10. The power supply system of claim 9, wherein the controller is further configured to perform:
as the level decreases from the high level to the low level, successively disabling the remaining switching power supplies until all the remaining switching power supplies are disabled.

11. The power supply system of claim 9, wherein the controller is further configured to perform:
establishing enable thresholds that increase successively for respective ones of the remaining switching power supplies; and
as the level increases, comparing the level against the enable thresholds,
wherein the controller is configured to perform successively enabling by successively enabling the remaining switching power supplies when the level exceeds successive ones of the enable thresholds, based on results of comparing.

12. The power supply system of claim 11, wherein the controller is further configured to perform:
establishing disable thresholds for respective ones of the remaining switching power supplies, such that each disable threshold is less than a respective one of the enable thresholds;
as the level decreases from the high level, comparing the level against the disable thresholds; and
as the level decreases, successively disabling the remaining switching power supplies that are enabled when the level falls below successive ones of the disable thresholds, based on results of comparing.

13. The power supply system of claim 9, wherein:
each switching power supply respectively includes a pulse width modulation (PWM) controller that, when enabled and disabled, supplies and does not supply PWM to one or more switching transistors; and
the controller is configured to perform enabling a particular switching power supply by enabling a particular PWM controller of the particular switching power supply.

14. The power supply system of claim 13, wherein:
the particular PWM controller includes an enable input to receive a voltage that enables or disables the particular PWM controller when the voltage exceeds or does not exceed a threshold voltage; and
the controller is configured to perform enabling the particular PWM controller includes applying the voltage that exceeds the threshold voltage to the enable input.

15. The power supply system of claim 13, wherein:
the particular PWM controller includes an enable input to receive a voltage that enables or disables the particular PWM controller when the voltage is less than or is not less than a threshold voltage; and
the controller is configured to perform enabling the particular PWM controller includes applying to the enable input the voltage that is less than the threshold voltage.

16. The power supply system of claim 13, wherein:
the particular PWM controller includes a duty cycle control input to receive a voltage to gradually increase a duty cycle of the PWM from zero to a maximum duty cycle as the voltage gradually increases from a low voltage to a high voltage; and
the controller is configured to perform enabling the particular PWM controller includes gradually increasing the voltage from the low voltage to the high voltage.

17. A method of controlling multiple power supplies connected in parallel to supply a total output power to a load, each power supply configured to, when enabled and disabled, respectively supply and not supply an individual power to the total output power, the method comprising:
establishing pairs of hysteretic thresholds that successively increase for respective ones of the multiple power supplies;
sensing a level of current indicative of the total output power; and
starting when the multiple power supplies are all disabled, controlling the multiple power supplies based on the level by:
as the level increases, successively enabling the multiple power supplies as the level successively exceeds enable thresholds of the pairs of the hysteretic thresholds until the multiple power supplies are all enabled; and
after the multiple power supplies are all enabled, as the level decreases, successively disabling the multiple power supplies as the level successively falls below disable thresholds of the pairs of the hysteretic thresholds.

18. The method of claim 17, wherein the multiple power supplies comprise switching power supply that include respective pulse width modulator (PWM) controllers, wherein:
successively enabling includes successively enabling the PWM controllers.

19. The method of claim 18, wherein:
successively disabling includes successively disabling the PWM controllers.

20. The method of claim 17, further comprising:
as the level increases, first comparing the level against the enable thresholds, and successively enabling based on first results of first comparing; and
as the level decreases, second comparing the level against the disable thresholds, and successively disabling based on second results of second comparing.
